(19) United States
(12) Patent Application Publication
(10) Pub. No.: US 2026/0086817 A1
(43) Pub. Date: Mar. 26, 2026

(54) MULTI-CLOUD BIOS SETTINGS

(71) Applicant: Dell Products L.P., Round Rock, TX (US)

(72) Inventors: Xueqiang ZHOU, Shanghai (CN); Jim Lewei JI, Shanghai (CN); Wayne M. SEVIGNY, Tyngsboro, MA (US); Ravindra KADIYALA, Austin, TX (US)

(73) Assignee: Dell Products L.P., Round Rock, TX (US)

(21) Appl. No.: 18/893,581

(22) Filed: Sep. 23, 2024

(51) Int. Cl. G06F 9/4401

(52) U.S. Cl. CPC G06F 9/4401

(57) ABSTRACT

An information handling system may include at least one processor, a memory, a network interface controller, and a Basic Input/Output System (BIOS). The information handling system may be configured to: be configured according to a first set of BIOS settings; during installation of a particular operating system (OS), communicate with a remote information handling system via the network interface controller to download a second set of BIOS settings, wherein the second set of BIOS settings is based on the particular OS; and apply the second set of BIOS settings.

### TECHNICAL FIELD

The present disclosure relates in general to information handling systems, and more particularly to customizing BIOS settings according to the operating system (OS) being installed on an information handling system, as well as its planned use case.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Some HCI systems use a cloud platform manager (e.g., APEX Cloud Platform™ from Dell®) for handling various cloud management tasks. For example, a cloud platform manager may be used to install a particular cloud OS onto an HCI cluster to prepare it for use with a particular cloud platform (e.g., Amazon® AWS, Microsoft® Azure, Google® Cloud Platform, etc.). The choice of a particular cloud platform for a cluster is sometimes referred to as the cluster's “cloud intent.”

During the manufacturing process, new cluster nodes are typically initially configured with factory default BIOS settings that are suitable for most use cases. For example, such BIOS settings may include enabling or disabling Secure Boot, settings relating to other security components, settings relating to performance, etc.

However, these common settings may not be compatible with (or optimal for) all cloud OS types, potentially causing conflicts. Consequently, the end user may need to manually adjust the BIOS settings to match those required for a specific cloud OS. This can be a complex and time-consuming process, especially when dealing with a large number of nodes. This process may then also need to be repeated each time the hardware is repurposed for a different cloud OS.

Embodiments of this disclosure simplify this process and obviate the need for manual intervention.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with BIOS settings in cluster environments may be reduced or eliminated.

In accordance with embodiments of the present disclosure, an information handling system may include at least one processor, a memory, a network interface controller, and a Basic Input/Output System (BIOS). The information handling system may be configured to: be configured according to a first set of BIOS settings; during installation of a particular operating system (OS), communicate with a remote information handling system via the network interface controller to download a second set of BIOS settings, wherein the second set of BIOS settings is based on the particular OS; and apply the second set of BIOS settings.

In accordance with these and other embodiments of the present disclosure, a method may include an information handling system being configured according to a first set of Basic Input/Output System (BIOS) settings; during installation of a particular operating system (OS), the information handling system communicating with a remote information handling system via a network interface controller to download a second set of BIOS settings, wherein the second set of BIOS settings is based on the particular OS; and the information handling system applying the second set of BIOS settings.

In accordance with these and other embodiments of the present disclosure, an article of manufacture may include a non-transitory, computer-readable medium having computer-executable instructions thereon that are executable by an information handling system for: being configured according to a first set of Basic Input/Output System (BIOS) settings; during installation of a particular operating system (OS), communicating with a remote information handling system via a network interface controller to download a second set of BIOS settings, wherein the second set of BIOS settings is based on the particular OS; and applying the second set of BIOS settings.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example method, in accordance with embodiments of the present disclosure.

### DETAILED DESCRIPTION

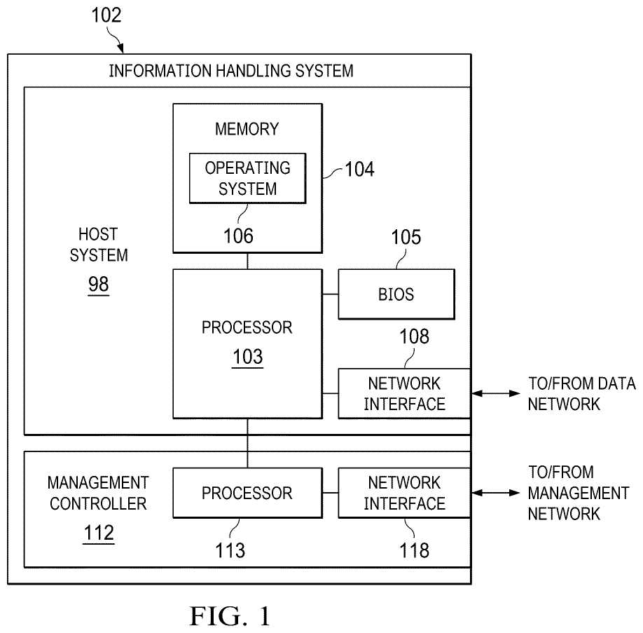

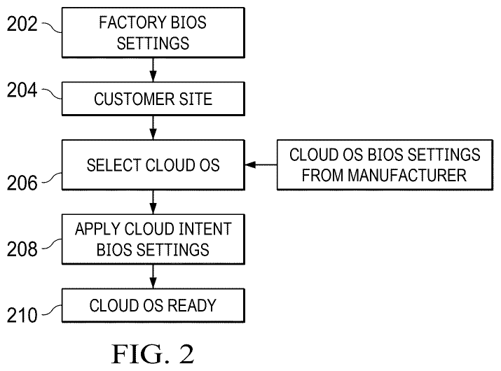

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, the BIOS settings of information handling system may need to be customized based on its cloud intent.

FIG. 2 shows an example method for accomplishing this, according to some embodiments. At step 202, the factory default BIOS settings are loaded onto an information handling system (e.g., during manufacturing). The information handling system is then shipped to the customer site at step 204.

Once the customer receives the information handling system, it may be set up as a node of a cluster. The customer may connect cables and power on the system, which may then boot to a generic bootstrap OS that allows for selection of the desired cloud intent. The customer thus selects the desired cloud OS at step 206, and the system retrieves the BIOS settings that are appropriate for that cloud OS from a manufacturer system (e.g., a website).

In some embodiments, when a user selects a cloud intent for a new system, the manufacturer may transmit various provisioning data to the system (e.g., a cloud OS image, other software, firmware updates, etc.). The BIOS settings according to the present disclosure may thus be included in that same payload.

Once that payload has been received, the information handling system may apply the cloud intent BIOS settings at step 208. The cloud OS and other software may also be installed onto the node at this step, and the node is ready to use at step 210.

One of ordinary skill in the art with the benefit of this disclosure will understand that the preferred initialization point for the method depicted in FIG. 2 and the order of the steps comprising that method may depend on the implementation chosen. In these and other embodiments, these method may be implemented as hardware, firmware, software, applications, functions, libraries, or other instructions. Further, although FIG. 2 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Embodiments may thus operate according to a two phase BIOS setup. This first phase of BIOS settings may be used to provide a basic level of functionality and compatibility that works for all types of information handling systems, regardless of their specific hardware configurations or cloud intents.

When the cloud platform manager is run and the customer chooses to install a particular cloud OS on the system, a second phase of BIOS settings may be applied. This second phase of BIOS settings may be fine-tuned specifically for the chosen operating system, in order to optimize the system's performance and ensure maximum compatibility.

Dividing the BIOS settings into two phases allows a manufacturer to provide a more customized and tailored experience for their customers, while still maintaining a common baseline of functionality that works for all information handling systems. This approach ensures that each system is optimized for the specific cloud OS that the customer chooses to install, without requiring the customer to manually adjust the BIOS settings with second touch.

Additionally, sometimes an information handling system may later be repurposed for a different cloud intent. When the user performs the reinstallation of a different cloud OS, the installer may again contact a manufacturer server to determine the most appropriate BIOS settings for the new role, applying those settings when carrying out the installation.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S. C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a memory;
a network interface controller; and
a Basic Input/Output System (BIOS);
wherein the information handling system is configured to:
be configured according to a first set of BIOS settings;
during installation of a particular operating system (OS), communicate with a remote information handling system via the network interface controller to download a second set of BIOS settings, wherein the second set of BIOS settings is based on the particular OS; and
apply the second set of BIOS settings.

2. The information handling system of claim 1, wherein the BIOS is a Unified Extensible Firmware Interface (UEFI) BIOS.

3. The information handling system of claim 1, further configured to execute a bootstrap OS prior to installation of the particular OS.

4. The information handling system of claim 3, wherein the bootstrap OS is configured to accept a user selection of which particular OS to install.

5. The information handling system of claim 1, wherein the particular OS is a cloud OS associated with a particular cloud intent, and wherein the information handling system is an element of an information handling system cluster.

6. The information handling system of claim 1, further configured to:
receive an instruction to install a different OS;
during installation of the different OS, communicate with a remote information handling system via the network interface controller to download a third set of BIOS settings, wherein the third set of BIOS settings is based on the different OS; and
apply the third set of BIOS settings.

7. A method comprising:
an information handling system being configured according to a first set of Basic Input/Output System (BIOS) settings;
during installation of a particular operating system (OS), the information handling system communicating with a remote information handling system via a network interface controller to download a second set of BIOS settings, wherein the second set of BIOS settings is based on the particular OS; and
the information handling system applying the second set of BIOS settings.

8. The method of claim 7, wherein the BIOS is a Unified Extensible Firmware Interface (UEFI) BIOS.

9. The method of claim 7, further comprising executing a bootstrap OS prior to installation of the particular OS.

10. The method of claim 9, wherein the bootstrap OS is configured to accept a user selection of which particular OS to install.

11. The method of claim 7, wherein the particular OS is a cloud OS associated with a particular cloud intent, and wherein the information handling system is an element of an information handling system cluster.

12. The method of claim 7, further comprising:
receiving an instruction to install a different OS;
during installation of the different OS, communicating with a remote information handling system via the network interface controller to download a third set of BIOS settings, wherein the third set of BIOS settings is based on the different OS; and
applying the third set of BIOS settings.

13. An article of manufacture comprising a non-transitory, computer-readable medium having computer-executable instructions thereon that are executable by an information handling system for:
being configured according to a first set of Basic Input/Output System (BIOS) settings;
during installation of a particular operating system (OS), communicating with a remote information handling system via a network interface controller to download a second set of BIOS settings, wherein the second set of BIOS settings is based on the particular OS; and
applying the second set of BIOS settings.

14. The article of claim 13, wherein the BIOS is a Unified Extensible Firmware Interface (UEFI) BIOS.

15. The article of claim 13, wherein the instructions are further executable for executing a bootstrap OS prior to installation of the particular OS.

16. The article of claim 15, wherein the bootstrap OS is configured to accept a user selection of which particular OS to install.

17. The article of claim 13, wherein the particular OS is a cloud OS associated with a particular cloud intent, and wherein the information handling system is an element of an information handling system cluster.

18. The article of claim 13, wherein the instructions are further executable for:
receiving an instruction to install a different OS;
during installation of the different OS, communicating with a remote information handling system via the network interface controller to download a third set of BIOS settings, wherein the third set of BIOS settings is based on the different OS; and
applying the third set of BIOS settings.
